(19) United States
(12) Patent Application Publication
(10) Pub. No.: US 2009/0231859 A1
(43) Pub. Date: Sep. 17, 2009

(54) Brightness Enhancement Component

(75) Inventors: Tou-Sheng Yeh, Ping Chen (TW); Chang-Yi Chen, Ping Chen (TW); Ming-Che Yang, Ping Chen (TW); Horng-Chin Yeh, Ping Chen (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: ITEQ CORPORATION, Ping Chen (TW)

(21) Appl. No.: 12/190,845

(22) Filed: Aug. 13, 2008

(30) Foreign Application Priority Data
Mar. 12, 2008 (TW) 97204232
Mar. 12, 2008 (TW) 97204233

(51) Int. Cl. F21V 5/02

(52) U.S. Cl. 362/339

(57) ABSTRACT

A brightness enhancement component includes a substrate and a plurality of prism elements. The prism elements are disposed on the substrate, and each element prism has a relatively high crest and at least one relatively low crest. A crest line of the relatively low crest is equal to or shorter than a crest line of the relatively high crest in length. All of the relatively high crests have their crest lines in parallel with one another, or all of the relatively high and relatively low crests have their crest lines in parallel with one another.

### RELATED APPLICATIONS

This application claims priority to Taiwan Application Serial Numbers 97204232 and 97204233, both filed Mar. 12, 2008, which are herein incorporated by reference.

### BACKGROUND

1. Field of Invention

The present invention relates generally to a brightness enhancement film, and more particularly, relates to the brightness used in a backlit liquid crystal display.

2. Description of Related Art

A backlit liquid crystal display generally includes a brightness enhancement film which is typically positioned between a diffuser and a liquid crystal display panel. The backlit liquid crystal display also includes a light source such as a fluorescent lamp, a light guide for transporting light for reflection toward the liquid crystal display panel, and white reflector for reflecting light toward the liquid crystal display panel. The brightness enhancement film collimates light emitted from the light guide thereby increasing the brightness of the liquid crystal display panel. The increased brightness enables a sharper image to be produced by the liquid crystal display panel and allows the power of the light source to be reduced to produce a selected brightness. The brightness enhancement film in the backlit liquid crystal display is useful in equipment such as computers, personal TVs, video recorders, mobile communication devices, and automobile and avionics instrument displays.

### SUMMARY

It is therefore an objective of the present invention to provide a brightness enhancement component.

In accordance with the foregoing and other objectives of the present invention, a brightness enhancement component comprises a substrate and a plurality of prism elements. The prism elements are disposed on the substrate, and each element prism has a relatively high crest and at least one relatively low crest. A crest line of the relatively low crest is shorter than a crest line of the relatively high crest, wherein all of the relatively high crests have their crest lines in parallel with one another.

In accordance with the foregoing and other objectives of the present invention, a brightness enhancement component comprises a substrate and a plurality of prism elements. The prism elements are disposed on the substrate, and each element prism has a relatively high crest and at least one relatively low crest. A crest line of the relatively low crest is equal to a crest line of the relatively high crest in length, wherein all of the relatively high crests and relatively low crests have their crest lines in parallel with one another.

The brightness enhancement components discussed in preferred embodiments can be used in an illumination device, i.e. a lamp, and flat panel displays, i.e. a liquid crystal display, to improve its brightness performance. In addition, the improved design on the prism element, i.e. the relative high and relative low crest, can effectively reduce Moiré effects or patterns.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 illustrates a brightness enhancement component according to one preferred embodiment of this invention;

FIG. 2 illustrates a cross-sectional view of the brightness enhancement component as illustrated in FIG. 1;

FIGS. 3 and 4 respectively illustrate enlarged cross-sectional views of a prism element as illustrated in FIG. 2;

FIG. 5 illustrates a brightness enhancement component according to another preferred embodiment of this invention;

FIG. 6 illustrates a cross-sectional view of the brightness enhancement component as illustrated in FIG. 5; and

FIGS. 7 and 8 respectively illustrate enlarged cross-sectional views of a prism element as illustrated in FIG. 6.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

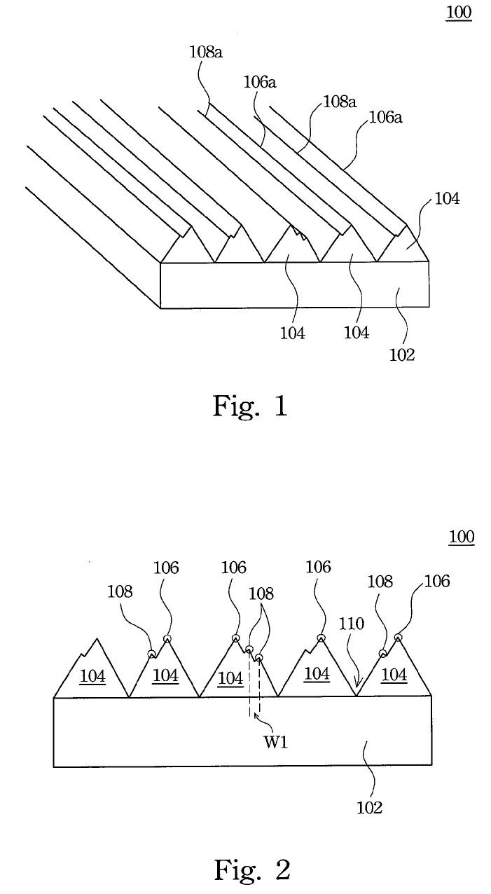

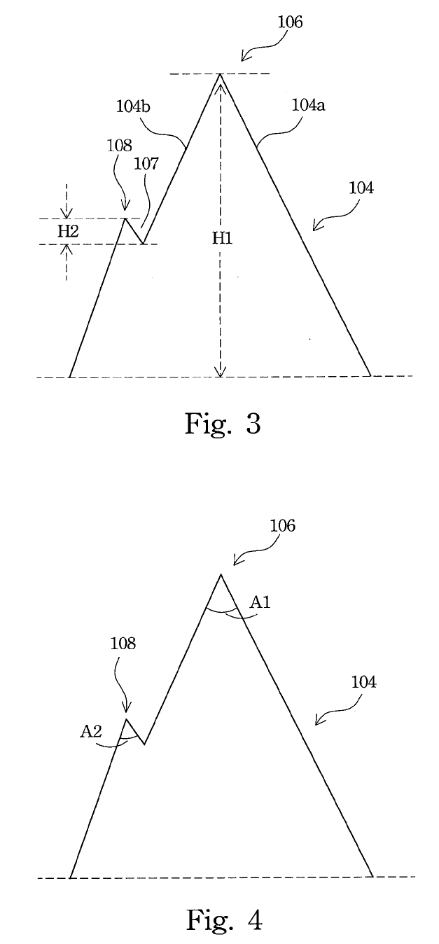

Referring to FIGS. 1 and 2, a brightness enhancement component 100 and its cross-sectional view are illustrated. The brightness enhancement component 100 includes a substrate 102 and a plurality of prism elements 104 arranged on the substrate 102. Each prism element 104 basically consists of two opposite facets, i.e. facets 104a, 104b as illustrated in FIG. 3, which intersect at the relatively high crest 106. Each prism element 104 also includes a relatively high crest 106 and at least one relatively low crest 108. All crest lines (106a, 108a) of the relatively high crests 106 and relatively low crests 108 are in parallel with one another. In each prism element, a crest line of the relatively high crest is equal to a crest line of the relatively low crest in length. In one preferred embodiment, all the relatively low crests 108 are at either one of two opposite facets. In another preferred embodiment, the relatively low crests 108 are arranged at both of two opposite facets (not illustrated in drawings). In another preferred embodiment, an interval W₁ between immediately-adjacent two of the relatively low crests 108 at one of the two opposing facets measures between 2 microns and 15 microns. In still another preferred embodiment, a V-shaped (in cross-sectional view) prism trough 110 is formed between immediately-adjacent two prism elements 104.

Referring to FIGS. 3 and 4, an enlarged cross-sectional view of single prism element is illustrated.

In FIGS. 3 and 4, several critical dimensions as to brightness enhancement are illustrated. In one preferred embodiment, the relatively high crest 106 has a height H₁ ranging from 10 microns to 100 microns above the substrate 102 (as illustrated in FIG. 2). In another preferred embodiment, the relatively high crest 106 has a height H₁ ranging from 10 microns to 50 microns above the substrate 102.

In one preferred embodiment, a ratio of H₂ to H₁ is less than 0.20. In another preferred embodiment, a ratio of H₂ to H₁ ranges from 0.01 to 0.10. Note that H₂ is a height of the relatively low crest 108 above a bottom of a V-shaped prism trough 107, which is formed between the relatively high crest 106 and the relatively low crest 108.

In one preferred embodiment, the relatively low crest 108 has a height H₂ ranging from 0.1 micron to 5.0 microns. In another preferred embodiment, the relatively low crest 108 has a height H₂ ranging from 1.0 micron to 2.0 microns.

In one preferred embodiment, the relatively low crest 108 is disposed higher than 66 percent of H₁ (a height of the relatively high crest 106) above the substrate in height. In another preferred embodiment, the relatively low crest 108 is disposed between 66 and 80 percent of H₁ (a height of the relatively high crest 106) above the substrate in height.

In one preferred embodiment, an included angle A₂ of the relatively low crest 108 measures between 70 degrees and 110 degrees. In another preferred embodiment, an included angle A₁ of the relatively high crest 106 measures between 70 degrees and 110 degrees.

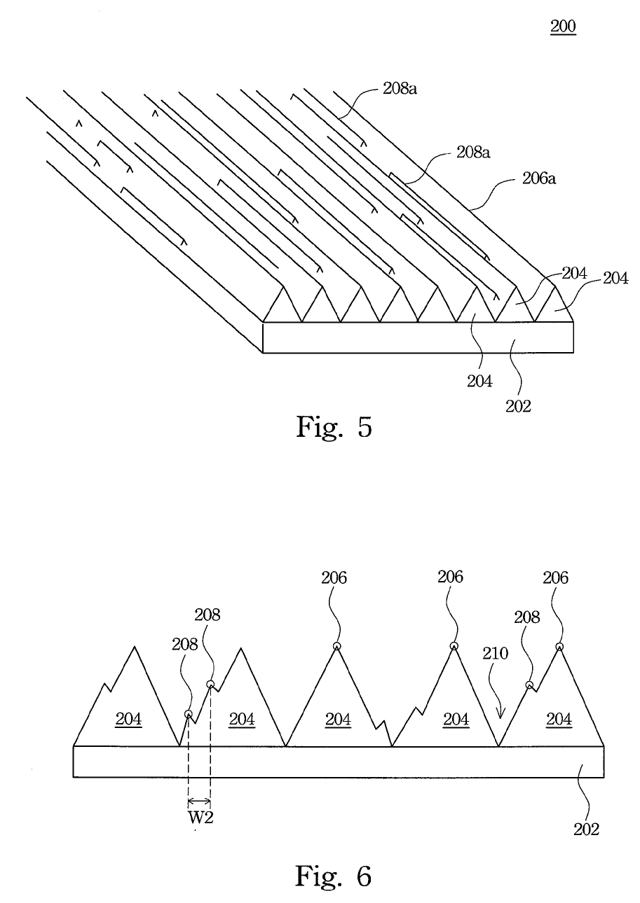

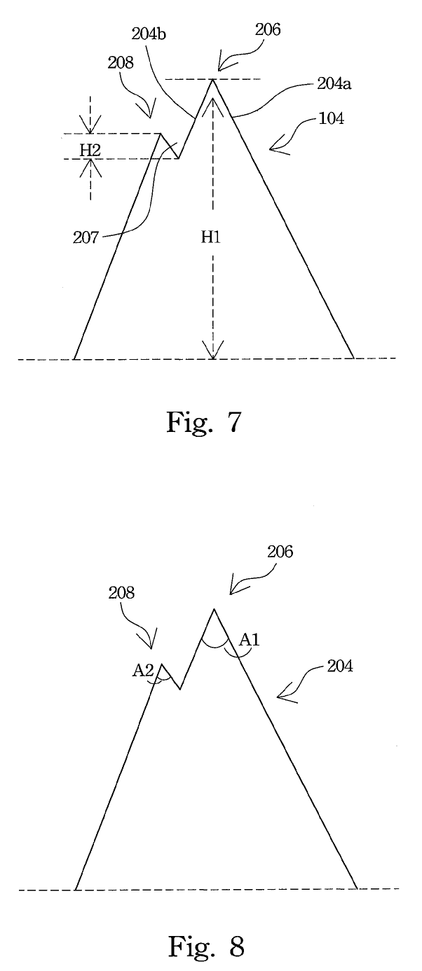

Referring to FIGS. 5 and 6, a brightness enhancement component 200 and its cross-sectional view are illustrated. The brightness enhancement component 200 includes a substrate 202 and a plurality of prism elements 204 arranged on the substrate 202. Each prism element 204 includes a relatively high crest 206 and at least one relatively low crest 208, and basically consists of two opposite facets, i.e. facets 204a, 204b as illustrated in FIG. 7, which intersect at the relatively high crest 206. All crest lines 206a of the relatively high crests 206 are in parallel with one another. A crest line 208a of the relatively low crest 208 is not a continuous crest line. That is, a crest line of the relatively low crest is shorter than a crest line of the relatively high crest in length in each prism element.

In one preferred embodiment, all crest lines (206a and 208a) of the relatively high crests 206 and the relatively low crests 208 are in parallel with one another. In another preferred embodiment, crest lines 208a of the relatively low crests 208 are not in parallel with crest lines 206a of the relatively high crests 206, or part crest lines 208a of the relatively low crests 208 are not is in parallel with crest lines 206a of the relatively high crests 206.

In one preferred embodiment, the relatively low crests 208 are all at either one of two opposite facets. In another preferred embodiment, the relatively low crests 208 are arranged at both of two opposite facets (not illustrated in drawings). In another preferred embodiment, an interval W₂ between immediately-adjacent two of the relatively low crests 208 at one of the two opposing facets measures between 2 microns and 15 microns. In still another preferred embodiment, a V-shaped (in cross-sectional view) prism trough 210 is formed between immediately-adjacent two prism elements 204.

Referring to FIGS. 7 and 8, an enlarged cross-sectional view of single prism element is illustrated.

In FIGS. 7 and 8, several critical dimensions as to brightness enhancement are illustrated. In one preferred embodiment, the relatively high crest 206 has a height H₁ ranging from 10 microns to 100 microns above the substrate 202. In another preferred embodiment, the relatively high crest 206 has a height H₁ ranging from 10 microns to 50 microns above the substrate 202.

In one preferred embodiment, a ratio of H₂ to H₁ is less than 0.20. In another preferred embodiment, a ratio of H₂ to H₁ ranges from 0.01 to 0.10. Note that H₂ is a height of the relatively low crest 208 above a bottom of V-shaped prism trough 207, which is formed between the relatively high crest 206 and the relatively low crest 208.

In one preferred embodiment, the relatively low crest 208 has a height H₂ ranging from 0.1 micron to 5.0 microns. In another preferred embodiment, the relatively low crest 208 has a height H₂ ranging from 1.0 micron to 2.0 microns.

In one preferred embodiment, the relatively low crest 208 is disposed higher than 66 percent of H₁ (a height of the relatively high crest 206) above the substrate in height. In another preferred embodiment, the relatively low crest 208 is disposed between 66 and 80 percent of H₁ (a height of the relatively high crest 206) above the substrate in height.

In one preferred embodiment, an included angle A₂ of the relatively low crest 208 measures between 70 degrees and 110 degrees. In another preferred embodiment, an included angle A₁ of the relatively high crest 206 measures between 70 degrees and 110 degrees.

The brightness enhancement components discussed in preferred embodiments can be used in an illumination device, i.e. a lamp, and flat panel displays, i.e. a liquid crystal display, to improve its brightness performance. In addition, the improved design on the prism element, i.e. the relative high crest and relative low crest, can effectively reduce Moiré effects or patterns when the brightness enhancement components are applied within a backlight module.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A brightness enhancement component comprising:
a substrate; and
a plurality of prism elements being disposed on the substrate, each element prism having a relatively high crest and at least one relatively low crest, a crest line of the relatively low crest being shorter than the a crest line of the relatively high crest in length, wherein all of the relatively high crests have their crest lines in parallel with one another.

2. The brightness enhancement component of claim 1, wherein a height ratio of the relatively low crest to the relatively high crest in each prism element is less than about 0.2.

3. The brightness enhancement component of claim 2, wherein a height ratio of the relatively low crest to the relatively high crest in each prism element is from about 0.01 to about 0.1.

4. The brightness enhancement component of claim 1, further comprising a V-shaped trough between immediately-adjacent two of the prism elements.

5. The brightness enhancement component of claim 1, further comprising a V-shaped trough between the relatively high crest and the relatively low crest of each prism element.

6. The brightness enhancement component of claim 5, wherein the relatively high crest measures between 10 microns and 100 microns above the substrate in height, the relatively low crest measures between 0.1 micron and 5.0 microns above a bottom of the V-shaped trough in height.

7. The brightness enhancement component of claim 6, wherein the relatively high crest measures between 10 microns and 50 microns above the substrate in height, the relatively low crest measures between 1.0 micron and 2.0 microns above a bottom of the V-shaped trough in height.

8. The brightness enhancement component of claim 1, wherein each element prism has two opposing facets which intersect at the relatively high crest, an interval between immediately-adjacent two of the relatively low crests at one of the two opposing facets measures between 2 microns and 15 microns.

9. The brightness enhancement component of claim 1, wherein an included angle of the relatively low crest measures between 70 degrees and 110 degrees, an included angle of the relatively high crest measures between 70 degrees and 110 degrees.

10. The brightness enhancement component of claim 1, wherein all of the relatively high crests and relatively low crests have their crest lines in parallel with one another.

11. A brightness enhancement component comprising:
a substrate; and
a plurality of prism elements being disposed on the substrate, each element prism having a relatively high crest and at least one relatively low crest, a crest line of the relatively low crest being equal to a crest line of the relatively high crest in length, wherein all of the relatively high crests and relatively low crests have their crest lines in parallel with one another.

12. The brightness enhancement component of claim 11, wherein a height ratio of the relatively low crest to the relatively high crest in each prism element is less than about 0.2.

13. The brightness enhancement component of claim 12, wherein a height ratio of the relatively low crest to the relatively high crest in each prism element is from about 0.01 to about 0.1.

14. The brightness enhancement component of claim 11, further comprising a V-shaped trough between immediately-adjacent two of the prism elements.

15. The brightness enhancement component of claim 11, further comprising a V-shaped trough between the relatively high crest and the relatively low crest of each prism element.

16. The brightness enhancement component of claim 15, wherein the relatively high crest measures between 10 microns and 100 microns above the substrate in height, the relatively low crest measures between 0.1 micron and 5.0 microns above a bottom of the V-shaped trough in height.

17. The brightness enhancement component of claim 16, wherein the relatively high crest measures between 10 microns and 50 microns above the substrate in height, the relatively low crest measures between 1.0 micron and 2.0 microns above a bottom of the V-shaped trough in height.

18. The brightness enhancement component of claim 11, wherein each element prism has two opposing facets which intersect at the relatively high crest, an interval between immediately-adjacent two of the relatively low crests at one of the two opposing facets measures between 2 microns and 15 microns.

19. The brightness enhancement component of claim 11, wherein an included angle of the relatively low crest measures between 70 degrees and 110 degrees, an included angle of the relatively high crest measures between 70 degrees and 110 degrees.

20. The brightness enhancement component of claim 11, wherein the relatively high crest measures a first distance above the substrate in height, the relatively low crest is disposed between 66 and 80 percent of the first distance above the substrate in height.
